(19) United States
(12) Patent Application Publication
(10) Pub. No.: US 2020/0071229 A1
(43) Pub. Date: Mar. 5, 2020

(54) METHOD AND DEVICE FOR PRODUCING AN EXPANDED GRANULATE

(71) Applicant: Binder + Co AG, Gleisdorf (AT)

(72) Inventors: Ernst Erwin BRUNNMAIR, Graz (AT); Gerhard SALCHINGER, Sinabelkirchen (AT)

(73) Assignee: Binder + Co AG, Gleisdorf (AT)

(21) Appl. No.: 16/605,614

(22) PCT Filed: Apr. 18, 2017
(86) PCT No.: PCT/AT2017/060097

§ 371 Date: Oct. 16, 2019

(51) Int. Cl. C04B 20/06; F27B 1/00; F27D 19/00; F27D 21/00; F27B 1/16; F27B 1/28

(52) U.S. Cl. CPC C04B 20/066; F27B 1/005; F27D 19/00; F27D 2019/0003; F27B 1/16; F27B 1/28; F27D 21/00

(57) ABSTRACT

A method for producing an expanded granulate made of a sand grain-shaped mineral material uses a propellant. The material is transported along a transport path through multiple heating zones in a furnace shaft, heated to a critical temperature at which the surfaces of the sand grains plasticize, and the sand grains are expanded based on the propellant. The material is fed from the bottom together with an amount of air; the material is transported from the bottom to the top along the transport path by the air quantity which flows from the bottom to the top in the furnace shaft and the sand grains are expanded in the upper half of the transport path. The material is heated such that the material immediately prior to entering into the furnace shaft is at a material entry temperature lower than the critical temperature and higher than the ambient temperature.

### FIELD OF INVENTION

The present invention relates to a method for producing an expanded granulate made of sand grain-shaped mineral material with an expanding agent, for example for the production of an expanded granulate of perlite or obsidian sand; wherein the material is fed into a furnace; wherein the material is conveyed in a substantially vertically disposed furnace shaft of the furnace along a conveying path through several heating zones arranged vertically separated from each other, wherein each heating zone can be heated with at least one independently controllable heating element; wherein the material is thereby heated to a critical temperature at which the surfaces of the sand grains become plastic and the sand grains are expanded due to the expanding agent; wherein the expanded material is discharged from the furnace, wherein furthermore the material is fed in together with a quantity of air from below, wherein the material is conveyed from bottom to top along the conveying path by means of the quantity of air flowing from bottom to top in the furnace shaft and forming an air flow, and wherein the expansion of the sand grains takes place in the upper half, preferably in the uppermost third, of the conveying path.

Furthermore, the present invention relates to a device for producing an expanded granulate of sand grain-shaped mineral material with an expanding agent, for example for the production of an expanded granulate of perlite or obsidian sand, the device comprising a furnace with a substantially vertically disposed furnace shaft, which has an upper end and a lower end, wherein between the two ends there extends a conveying path which leads through several heating zones arranged vertically separated from each other, wherein the heating zones each have at least one independently controllable heating element in order to heat the material to a critical temperature and to expand the sand grains, wherein further at least one feed means is provided to inject the non-expanded material together with a quantity of air at the lower end of the furnace shaft towards the upper end of the furnace shaft into the furnace shaft so that the quantity of air forms an upwardly flowing air flow, by means of which the material is conveyed from bottom to top along the conveying path in order to be expanded in the upper half, preferably in the uppermost third, of the conveying path.

### DESCRIPTION OF THE PRIOR ART

From the AT 15001 U1 a method and a device for closed-cell expansion of mineral materials, in particular of sands from volcanic rocks such as perlite or obsidian, with very small grain sizes of less than 100 μm are known. The processed raw sand is first dispersed in as narrow a grain band as possible, preferably using compressed air, and then fed from below into a vertical expansion shaft or furnace shaft comprising several independently controllable heating zones. In the furnace shaft itself, the heat is transferred by heat radiation from an inner surface of the furnace shaft to the grains.

Furthermore, convective heat transfer processes take place, namely on the one hand from the hot furnace shaft surface to the flowing medium and on the other hand due to the speed differences between the flowing medium and the grains from the grain to the flowing medium. It has been shown that these convective heat transfer processes lead to an undesired impairment of the uniformity of the expansion product. In particular, comparatively smaller grains are over-expanded with known methods and devices and comparatively larger grains are incompletely expanded or blown.

### OBJECT OF THE INVENTION

It is therefore the object of the present invention to provide an improved method and an improved device for the production of an expanded granulate from material with very small grain sizes, which avoids the aforementioned disadvantages and allows an increased uniformity of the expanded granulate.

### PRESENTATION OF THE INVENTION

Initially, the starting point of the present invention is the realization that regulating the flow velocity of the flowing medium, especially the air that is also used for dispersion, alone does not lead to the desired success. If an attempt is made to increase the residence time of coarser (sand) grains by keeping the flow velocity of the dispersing air in the furnace shaft as low as possible (longer residence time means higher energy transfer to the grain by heat radiation), the grains will be subjected as a result of the difference in velocity between the dispersing air and material to an energy loss due to convection to the dispersing air. If, on the other hand, an attempt is made to keep the speed difference between the dispersing air and the material as low as possible by means of the highest possible flow rate of the dispersing air, the residence time in the furnace shaft is no longer sufficient to heat the grains to softening temperature.

The idea of the present invention is now that the sand grain-shaped material is heated to a temperature below the softening point of the volcanic glass or below the critical temperature of the respective sand grain-shaped material before entering the furnace shaft. The amount of heat transferred from the grain to the medium and thus the time of expansion can be regulated very sensitively—even within a heating zone—by the level of this upstream heating. An increase in temperature (heating) causes an earlier onset of expansion and usually also leads to lighter granulates. A reduction of the temperature (of the heating) leads to opposite effects. A further advantage is that the reduced heat dissipation results in a more homogeneous temperature distribution in the grain and thus a more uniform expansion result.

In addition to the detection of the isenthalpic expansion process and the adaptation of the temperature profile in the shaft, the heating of the material offers an additional possibility to specifically influence the expansion result. In particular, heating can be used to ensure that expansion takes place in the last shaft element or in the upper half, preferably in the uppermost third of a conveying path in the furnace shaft, and never before it.

Therefore, it is provided according to the invention in a method for producing an expanded granulate of sand grain-shaped mineral material with an expanding agent, for example for producing an expanded granulate of perlite or obsidian sand; wherein the material is fed into a furnace; wherein the material is conveyed in a substantially vertically disposed furnace shaft of the furnace along a conveying path through a plurality of heating zones arranged vertically separated from each other, wherein each heating zone can be heated with at least one independently controllable heating element; wherein the material is thereby heated to a critical temperature at which the surfaces of the sand grains become plastic and the sand grains are expanded due to the expanding agent; wherein the expanded material is discharged from the furnace, wherein the material is further fed together with a quantity of air from below, wherein the material is conveyed from bottom to top along the conveying path by means of the quantity of air flowing from bottom to top in the furnace shaft and forming an air flow, and wherein the expansion of the sand grains in the upper half of the conveying path is carried out by means of the air flowing from bottom to top in the furnace shaft, preferably in the uppermost third, of the conveying path, that the material is heated so that the material has a material entry temperature immediately before its entry into the furnace shaft which is lower than the critical temperature and higher than an ambient temperature.

This means that the heating zones define the furnace shaft or the furnace shaft is the section of the furnace in which the heating zones are arranged.

“Substantially vertically disposed” means that a slight deviation from the vertical is possible, e.g. due to manufacturing fault tolerances.

The material entry temperature is the temperature of the material averaged over the fed material immediately before entering the furnace shaft. In any case, this material entry temperature can be calculated using the known energy input and the known mass flows. It is also conceivable that the material entry temperature can be measured.

The ambient temperature is preferably measured in an environment outside the furnace, in the immediate vicinity of the area where the material enters the furnace shaft.

Similarly, it is provided according to the invention in a device for producing an expanded granulate of sand grain-shaped mineral material with an expanding agent, for example for producing an expanded granulate of perlite or obsidian sand, the device comprising a furnace with a substantially vertically disposed furnace shaft having an upper end and a lower end, wherein a conveying path extends between the two ends and passes through a plurality of heating zones arranged vertically separated from one another, wherein the heating zones each have at least one heating element which can be controlled independently of one another in order to heat the material to a critical temperature and to expand the sand grains, wherein further at least one feed means is provided in order to expand the non-expanded material together with a quantity of air at the lower end of the furnace shaft towards the upper end of the furnace shaft into the furnace shaft in such a way that the quantity of air forms an air flow flowing from bottom to top, by means of which the material is conveyed from bottom to top along the conveying path in order to be expanded in the upper half, preferably in the uppermost third, of the conveying path, that at least one means is provided upstream of the furnace shaft for heating the material in order to ensure that the material, upon its entry into the furnace shaft, has a material entry temperature which is lower than the critical temperature and higher than an ambient temperature.

According to the above, the material entry temperature is the temperature of the material in an area located between the feed means and the furnace shaft.

The quantity of air is particularly suitable for heating the material. Accordingly, a preferred embodiment of the method according to the invention provides that the quantity of air is heated to a second elevated temperature which is lower than the critical temperature and higher than the ambient temperature. This means that the air heated to the second elevated temperature can be used to heat the material to the material entry temperature. Preferably, the material entry temperature is not the same as the second elevated temperature, especially smaller than the second elevated temperature.

Similarly, in a preferred embodiment of the device according to the invention, at least one means is provided upstream of the furnace shaft for heating the quantity of air to a second elevated temperature which is lower than the critical temperature and higher than the ambient temperature.

In a preferred embodiment of the method according to the invention, it is provided that the material is dispersed in the quantity of air before the material enters the furnace shaft. Accordingly, the dispersed material has the material entry temperature immediately before it enters the furnace shaft, which, as already stated above, can at least be determined by calculation. The dispersion ensures that the material enters the furnace shaft with as homogeneous a spatial distribution as possible and then flows through it. This prevents an unwanted formation of agglomerates of the sand grains to be expanded, which would subsequently lead to unwanted agglomerates of expanded microspheres.

Similarly, in a preferred embodiment of the device according to the invention, it is provided that the at least one feed means comprises a solid/air nozzle to which compressed air and the non-expanded material can be fed to disperse the material in the quantity of air. This means that the quantity of air is provided by the compressed air. Accordingly, the above-mentioned heating of the quantity of air can also take place by heating or warming up the compressed air. This heating can be made possible, for example, by a heating in a compressed air tank.

As an alternative or in addition to heating the material by means of the heated quantity of air or compressed air, it is provided in a preferred embodiment of the method according to the invention to heat the material to a first elevated temperature which is lower than the critical temperature and higher than the ambient temperature before dispersing. Basically, the first elevated temperature is a mean temperature averaged over the material before dispersing or before the nozzle. This means that individual sand bodies can have a temperature that deviates from the first elevated temperature.

Similarly, in a preferred embodiment of the device according to the invention, at least one means is provided upstream of the solid/air nozzle for heating the material to a first elevated temperature which is lower than the critical temperature and higher than the ambient temperature.

In order to enable a simple implementation of the heating of the air quantity in terms of design, it is provided in a preferred embodiment of the device according to the invention that the air quantity is heated to the second elevated temperature before dispersing.

Similarly, in a preferred embodiment of the device according to the invention, it is provided that the at least one means for heating the air quantity to the second increased critical temperature is connected upstream of the solid/air nozzle.

According to the above, in a preferred embodiment of the method according to the invention, it is provided that at least the quantity of air heated to the second elevated temperature is provided as a means of heating the material to the material entry temperature. This means that additional means can also be provided for heating the material to the material entry temperature.

Similarly, in a preferred embodiment of the device according to the invention, it is provided that at least the quantity of air heated to the second elevated temperature is provided as means for heating the material to the material entry temperature.

Alternatively or additionally, in a preferred embodiment of the method according to the invention, it is provided that at least one heating is provided with which heating the material is heated to the first elevated temperature in a storage container before dispersing. This means that this also contributes to the heating of the material to the material entry temperature or represents said heating alone.

Similarly, in a preferred embodiment of the device according to the invention, it is provided that a storage container for the material is provided and that the at least one means, upstream of the solid/air nozzle, for heating the material to the first elevated temperature comprises at least one heating, with which material located in the storage container can be heated.

In order to keep the costs for the method according to the invention as low as possible, it is provided in the case of a preferred embodiment of the method according to the invention that only the quantity of air heated to the second elevated temperature is provided as a means of heating the material to the material entry temperature. In particular, in this case no heated storage container for the material is provided for heating.

Similarly, in a preferred embodiment of the device according to the invention, only the quantity of air heated to the second elevated temperature is provided as a means of heating the material to the material entry temperature.

In the event that both the quantity of air is heated and the material is heated to the first elevated temperature, it has been shown to be advantageous for a particularly uniform expansion result that the first and second elevated temperatures are as equal as possible. Therefore, it is provided in a preferred embodiment of the method according to the invention that the absolute value of a differential temperature, which is the difference between the first elevated temperature and the second elevated temperature, is at most 50%, preferably at most 30%, particularly preferably at most 10%, of the first elevated temperature.

Similarly, in a preferred embodiment of the device according to the invention, it is provided that the absolute value of a differential temperature, which is the difference between the first elevated temperature and the second elevated temperature, is at most 50%, preferably at most 30%, more preferably at most 10%, of the first elevated temperature.

In order to optimize the expansion result in a particularly simple way, it is provided that, in a particularly preferred embodiment of the method according to the invention, the absolute value of the differential temperature is at most 2% of the first elevated temperature, wherein the differential temperature is preferably zero.

Similarly, in a particularly preferred embodiment of the device according to the invention, it is provided that the absolute value of the differential temperature is at most 2% of the first elevated temperature, wherein the differential temperature is preferably zero.

In the case of a preferred embodiment of the method according to the invention, it is provided that the second elevated temperature is lower than the first elevated temperature. As a result, small particles or grains experience a higher cooling rate than large ones, especially during dispersion, which is compensated in the subsequent furnace shaft due to the specifically larger surface area of the smaller particles. This results in an even more homogeneous end product in terms of quality.

Similarly, in a preferred embodiment of the device according to the invention, it is provided that the second elevated temperature is lower than the first elevated temperature.

In order to further optimize the expansion result as a function of the grain band, it is provided, in a particularly preferred embodiment of the method according to the invention, that the second elevated temperature is selected as a function of the grain band of the material, wherein the larger the grain band of the material, the lower the second elevated temperature is selected.

As already mentioned above, an additional possibility for regulation is the detection of the isenthalpic expansion process, which results in a drop in temperature, i.e. an abrupt reduction in the material temperature, and the corresponding adaptation of the temperature profile in the shaft. This means that this drop in temperature is not the result of a set temperature profile in the furnace shaft, but is due to the isenthalpic expansion process. The surface properties of the expanded grains can be specifically influenced by detecting the drop in temperature or the isenthalpic expansion process. For example, a renewed heating above the critical temperature can be prevented in order to prevent the surface from rupturing and, in particular, to obtain completely closed-cell expanded grains. Or such a renewed rise in temperature can be deliberately initiated if the surface of the expanded grains is deliberately to be torn open or even achieved. Accordingly, in a preferred embodiment of the method according to the invention, it is provided that upon detection of a first reduction in the temperature of the material between two successive positions along the conveying path, the heating elements along the remaining conveying path are regulated as a function of the critical temperature in order to prevent or specifically enable an increase in the material temperature along the remaining conveying path to or above the critical temperature.

Similarly, in a preferred embodiment of the device according to the invention, it is provided that material temperature measuring means are provided for the direct and/or indirect measurement of the temperature and/or the temperature change of the material along the conveying path, as well as a regulating and control unit which is connected to the material temperature measuring means and to the heating elements of the heating zones in order to detect a first reduction in the temperature of the material, preferably of at least 20° C., between two successive positions along the conveying path, and in that the heating elements can be regulated by the regulating and control unit as a function of the critical temperature, in order to prevent or selectively enable an increase in the material temperature along the remaining conveying path to or above the critical temperature.

In order to be able to regulate the expansion or expansion process even more sensitively, it is provided in a preferred embodiment of the method according to the invention that the size and/or density of the expanded sand grains is determined, preferably continuously, after they have been discharged. A bulk density measurement is preferably provided for this purpose. This can, for example, permanently check 60-90% of the expanded granulate with regard to the bulk density. The expansion result can be continuously monitored by the measurement and process parameters can be adjusted immediately if the expansion result deviates from the desired expansion result. This means that the density of the expanded sand grains can be specifically controlled.

Similarly, in a preferred embodiment of the device according to the invention, it is provided that means are provided for the, preferably ongoing, determination of the size and/or density of the expanded sand grains.

In order to regulate the density of the expanded grains in a particularly efficient way, it is provided in an especially preferred embodiment of the method according to the invention to regulate the density of the expanded sand grains by controlling the output of at least one heating element in a last heating zone. In particular, the power can be controlled to a desired value or to a value in a desired value range.

In this way, the density and homogeneity of the expanded sand grains can be regulated at least roughly.

Similarly, in a preferred embodiment of the device according to the invention, a regulating and control unit is provided which is designed in such a way that the power of at least one heating element of a last heating zone is controlled in order to regulate the density of the expanded sand grains. It may be the same regulating and control unit that is used for temperature control. The regulating and control unit is connected to the means for determining the density and to the at least one heating element of the last heating zone.

By setting a temperature or a temperature profile in the heating zones along the conveying path, the location or area of the conveying path where the isenthalpic expansion—and thus the temperature drop—takes place can at least be roughly set. In particular, the expansion can be shifted towards the end of the conveying path. In particular, the regulation can be carried out in such a way that the expansion takes place immediately before the last heating zone. Accordingly, in a preferred embodiment of the method according to the invention, it is provided that, in order to regulate a position of the detected first reduction of the temperature of the material up to the power of at least one heating element of a last heating zone, the powers of the heating elements of all heating zones are controlled. This means that the powers of the heating elements of all heating zones, except the last heating zone, are controlled to certain desired values or to values in certain desired value ranges.

Similarly, in a preferred embodiment of the device according to the invention, it is provided that the regulating and control unit is designed in such a way that, in order to regulate a position of the detected first reduction of the temperature of the material up to the power of the at least one heating element of a last heating zone, the powers of the heating elements of all heating zones are controlled.

Alternatively or additionally, the material entry temperature can be controlled in order to influence the position of the temperature drop along the conveying path. An extremely fine adjustment of this position is thus possible. The material entry temperature can be adjusted in particular by appropriate selection of the first and/or second elevated temperature. Therefore, it is provided in a preferred embodiment of the method according to the invention that the first elevated temperature and/or the second elevated temperature are controlled in order to regulate the position of the detected first reduction in the temperature of the material.

Similarly, in a preferred embodiment of the device according to the invention, it is provided that the regulating and control unit is designed in such a way that the first elevated temperature and/or the second elevated temperature are controlled in order to regulate the position of the detected first reduction in the temperature of the material.

In a preferred embodiment of the method according to the invention, it is provided that the first elevated temperature and/or the second elevated temperature are controlled in order to regulate the density and/or size of the expanded sand grains. This means that the first and/or second elevated temperature are controlled in such a way that they assume desired values or values in desired value ranges. This not only allows the point or area along the conveying path where the expansion takes place to be moved particularly finely, especially towards the end of the conveying path, but also allows the density and/or size and homogeneity of the expanded sand grains to be regulated particularly finely. The density and/or size are preferably used as the regulating variable.

Similarly, in a preferred embodiment of the device according to the invention, it is provided that a regulating and control unit is provided which is designed in such a way that the first elevated temperature and/or the second elevated temperature are controlled in order to regulate the density and/or size of the expanded sand grains. This may concern the same regulating and control unit which is used for temperature control; the regulating and control unit is connected to the means for determining density and/or size and to the at least one means for heating the material to the first elevated temperature and/or to the at least one means for heating the quantity of air to the second elevated temperature.

In accordance with the above, the homogeneity of density and/or size can also be used as a regulating variable, wherein the first and/or second elevated temperature are controlled in such a way that they assume desired values or values in desired value ranges. Accordingly, in a preferred embodiment of the method according to the invention, it is provided that the first elevated temperature and/or the second elevated temperature are controlled in order to regulate the homogeneity of the density and/or size of the expanded sand grains.

Similarly, in a preferred embodiment of the device according to the invention, it is provided that a regulating and control unit is provided which is designed in such a way that the first elevated temperature and/or the second elevated temperature are controlled in order to regulate the homogeneity of the density and/or size of the expanded sand grains. It may be the same regulating and control unit used for temperature control (for heating the material to the material entry temperature); the regulating and control unit is connected to the means for determining the density and/or size in order to determine the homogeneity of the density and/or size, and to the at least one means for heating the material to the first elevated temperature and/or to the at least one means for heating the quantity of air to the second elevated temperature.

In a preferred embodiment of the method according to the invention, it is provided that the material entry temperature is at least 30%, preferably at least 90%, of the critical temperature. Similarly, in a preferred embodiment of the device according to the invention, it is provided that the material entry temperature is at least 30%, preferably at least 90%, of the critical temperature.

In this way, particularly simple or reliable homogeneous expansion results can be achieved in practice.

In order to achieve particularly simple or reliable homogeneous expansion results, especially when expanding perlite and/or obsidian sand, it is provided that in a preferred embodiment of the method according to the invention the material entry temperature is at least 240° C., preferably at least 720° C. Similarly, in a preferred embodiment of the device according to the invention, it is provided that the material entry temperature is at least 240° C., preferably at least 720° C.

In a preferred embodiment of the method according to the invention, it is provided that additional supply air is blown into the furnace shaft from below and/or sucked in in order to support the conveying of the material along the conveying path, wherein the supply air is preheated to a further elevated temperature before it enters the furnace shaft. Preferably, the further elevated temperature is also higher than the ambient temperature and lower than the critical temperature. Since the raw sand is fed in from below, it must be conveyed through the furnace shaft against gravity, and this is done pneumatically, so to speak, with the supply air supporting this pneumatic conveying. The material is heated quickly in the furnace shaft. Preheating the supply air prevents a large part of the heating of the material caused by the heating process from being transferred to the supply air by convection. By heating or preheating the raw sand and the supply air before entering the furnace shaft, a shorter furnace shaft can be built or regulated in a much more sensitive manner.

Similarly, in a preferred embodiment of the device according to the invention, at least one means is provided for injecting and/or aspirating supply air from below into the furnace shaft in order to support the conveying of the material along the conveying path, and at least one means is provided for preheating the supply air to a further elevated temperature, which is connected upstream of the furnace shaft. Preferably, means for injecting (e.g. a fan or blower or compressor) are connected upstream of the furnace shaft and means for aspiration (e.g. a fan or blower) are connected downstream of the furnace shaft, wherein the supply air always enters the furnace shaft from below.

In a particularly preferred embodiment of the method according to the invention, it is provided that the preheated supply air is added to the material dispersed in the air quantity before it enters the furnace shaft. This allows a particularly simple technical or constructive realization. Preferably, the supply air is preheated to a temperature at least as high as that of the dispersed material. This prevents the material from cooling due to the addition of supply air.

Similarly, in a preferred embodiment of the device according to the invention, it is provided that the at least one means for injecting and/or aspirating the supply air comprises a pipe, which pipe is connected at least in sections on the one hand between the solid/air nozzle and the furnace shaft and on the other hand between the at least one means for preheating the supply air and the furnace shaft. This means that the arrangement of the pipe is such that the preheated air can be conveyed through it into a region between the solid/air nozzle and the furnace shaft or the lower end of the furnace shaft.

### SHORT DESCRIPTION OF THE FIGURES

The invention is now explained in more detail using embodiment examples.

The drawings are exemplary and are intended to illustrate the idea of invention, but in no way to restrict it or even render it conclusively, wherein:

FIG. 1 shows a flow diagram of a first embodiment of a device according to the invention for performing a first embodiment of the method according to the invention, wherein material to be expanded is heated by means of heated compressed air before it enters a furnace shaft from below, wherein the compressed air forms a quantity of air in which the material is dispersed before it enters the furnace shaft;

FIG. 2 shows a flow diagram of a second embodiment of the device according to the invention for carrying out a second embodiment of the method according to the invention, wherein the material to be expanded is heated by means of a heated storage container before it is dispersed and subsequently enters the furnace shaft;

FIG. 3 shows a flow diagram of a third embodiment of the device according to the invention for carrying out a third embodiment of the method according to the invention, wherein the material to be expanded is heated both by means of the heated compressed air and by means of the heated storage container before it enters the furnace shaft;

FIG. 4 shows a flow diagram of a fourth embodiment of the device according to the invention for carrying out a fourth embodiment of the method according to the invention, wherein, in contrast to the third embodiment according to FIG. 3, additionally preheated supply air is blown into the furnace shaft from below.

### DETAILED DESCRIPTION OF THE PREFERRED EMBODIMENTS

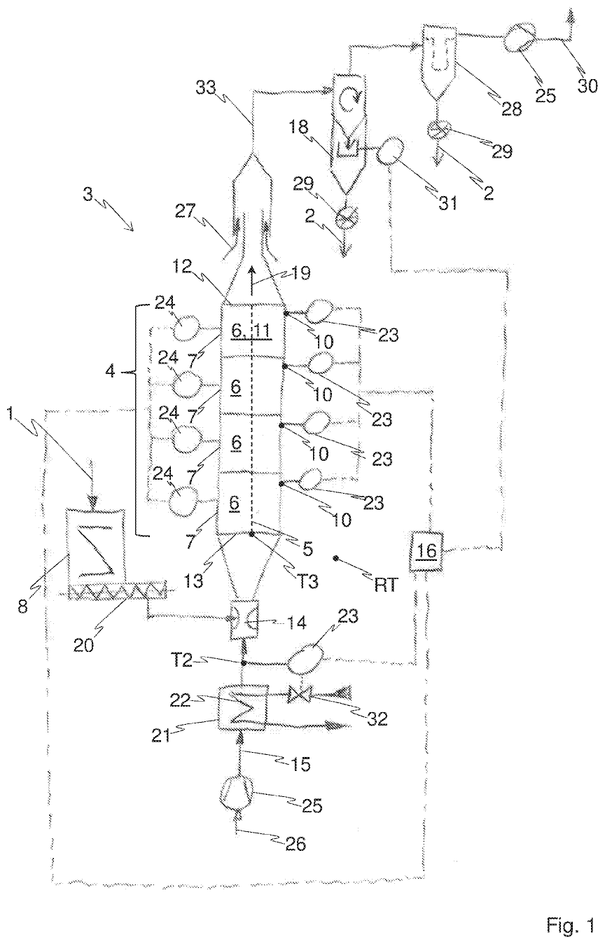

FIG. 1 shows a schematic representation of a first embodiment of a device according to the invention with which a first embodiment of a method according to the invention for the production of expanded microspheres 2 or expanded granules 2 can be carried out. The starting material for the expanded microspheres 2 is a sand-like or powdery, in particular mineral, material with an expanding agent. In the embodiment example shown, perlite sand 1 is assumed to be the material, wherein water is bound in perlite and acts as an expanding agent in the expansion process. The diameter of the perlite sand grains 1 is typically smaller than 100 μm.

To carry out the expansion process, the device according to the invention comprises a furnace 3 with a furnace shaft 4, which extends essentially vertically—i.e. a slight deviation from the vertical is possible, e.g. due to manufacturing fault tolerances—from a lower end 13 to an upper end 12 from bottom to top. A conveying path 5 extends between the ends 13, 12, which is indicated by a dotted line in FIG. 1. This line also marks a radial center of the furnace shaft 4.

In furnace shaft 4, several heating zones 6 are provided, arranged one above the other or one after the other in a conveying direction 19, through which the conveying path 5 passes. This means that heating zones 6 define furnace shaft 4 or furnace shaft 4 is the section of furnace 3 in which heating zones 6 are arranged.

Each heating zone 6 is equipped with at least one independently controllable heating element 7, which may in particular be an electric heating element 7. Using the heating elements 7, perlite sand 1 can be brought to a critical temperature in furnace 3 or furnace shaft 4 at which the surfaces of the perlite sand grains 1 become plastic and the perlite sand grains 1 are expanded due to the expanding agent—in this case water vapor.

The perlite sand 1 is fed together with a quantity of air at the lower end 13 into the furnace 3 or furnace shaft 4 and blown in the direction of the upper end 12, i.e. from bottom to top. A solid/air nozzle 14 is provided for this injection. The perlite sand 1, which is stored in a storage container 8, is fed to said nozzle via a dosing screw 20. On the other hand, the solid/air nozzle 14 is supplied with compressed air 15 from a compressed air tank 21.

The solid/air nozzle 14 ensures that an air flow is formed from bottom to top, by means of which the perlite sand 1 is conveyed from bottom to top along the conveying path 5 in conveying direction 19. By conveying from bottom to top, it is generally prevented that the buoyancy forces that arise cause the residence time of perlite sand 1 or expanded granulate 2 in the furnace shaft 4 to become uncontrollably long. At the same time, it can be ensured that the expansion only takes place in the upper half, preferably in the upper third of the furnace shaft 4 or the conveying path 5, wherein a caking of the perlite sand 1 or the expanded granulate 2 on an inner wall of the furnace shaft 4 can be avoided as well as a sticking together of individual grains of the perlite sand 1 or the expanded granulate 2 among each other.

Perlite sand 1 typically has a temperature of approx. 780° C. immediately before its expansion. Since the expansion process, in which the perlite sand grains 1 expand, is an isenthalpic process, the perlite sand 1 cools down during expansion, typically to approx. 590° C., which is also referred to as a drop in temperature. Depending on the material, the temperature drop is at least 20° C., preferably at least 100° C. Detection of the temperature drop or detection of the position at which the temperature drop occurs in the furnace shaft 4 makes it possible to regulate the heating elements 7 in a targeted manner along the remaining conveying path 5, in particular to influence the surface structure or surface properties of the expanded granulate 2.

Accordingly, a large number of positions 10 are provided along conveying path 5 for temperature measurement in order to determine the position of the drop in temperature or the position of an initial reduction in the temperature of the material due to isenthalpic expansion. In the embodiment examples shown, temperature sensors 23 are provided for temperature measurement, which are connected to a regulating and control unit 16 (indicated by the dashed lines) and whose data are evaluated by the regulating and control unit 16.

However, it is also conceivable not to carry out an absolute temperature measurement but to determine the power consumption of the heating elements 7 or to determine how this power consumption changes along the conveying path 5. The corresponding power measurements can be carried out by means of current or power measuring instruments 24, which are provided for the heating elements 7 of the heating zones 6 in the illustrated embodiments. The current and power meters 24 are connected to the regulating and control unit 16 (indicated by the dashed lines), which can evaluate the data of the current and power meters 24, respectively.

Immediately after the expansion process and the resulting drop in temperature, the temperature difference between the expanded granulate 2 and the heating elements 7 is significantly greater than between the perlite sand 1 and the heating elements 7 immediately before the expansion process. The heat flow also increases accordingly. This means that the change in the heat flow or power consumption of the heating elements 7 from one heating zone 6 to the next is an increase, whereas the change in the power consumption along the conveying path 5 is a decrease due to the successive heating of perlite sand 1 before the expansion process.

The heating elements 7 are also connected to the regulating and control unit 16 (indicated by the dashed lines) for regulation, in particular for regulation along the conveying path 5 remaining after the temperature drop, so that an increase in the material temperature along the remaining conveying path 5 to or above the critical temperature can be specifically prevented or made possible.

The thus produced expanded microspheres 2 typically have a diameter of less than or equal to 150 μm. In order to actually obtain individual expanded microspheres 2 in the end product and not too large particles in the form of agglomerates of expanded microspheres 2, it must be prevented that the perlite sand 1 in the furnace shaft 4 forms agglomerates which are then expanded to corresponding agglomerates of expanded microspheres 2. Agglomeration of perlite sand 1 is favored by moisture. Therefore, perlite sand 1 is typically processed before it reaches the storage container 8, wherein the processing includes a drying process. In addition, an agitator may be provided in the storage container 8 to prevent bridging between the perlite sand grains 1. Since, however, even in the dry state, it is hardly possible to convey the fine dust perlite sand 1 without forming agglomerates, the perlite sand 1 is dispersed in the air quantity with which it is fed into the furnace shaft 4 by means of the solid/air nozzle 14.

After the expansion process, the expanded granulate 2 is discharged together with the air heated in the furnace shaft 4 at the upper end 12 of the furnace shaft 4. This means that the expanded microspheres 2 are present in a gas-material stream 33.

Cooling air 27 is added to the gas-material flow 33 after it has left the furnace shaft 4. This cools the expanded granulate 2, preferably to a processing temperature of less than or equal to 100° C., which facilitates further handling of the expanded granulate 2, especially during further processing.

In order to be able to achieve an improved expansion result, in particular with increased uniformity, it is provided in accordance with the invention that the perlite sand 1 is heated before it enters the furnace shaft 4, so that the perlite sand 1 immediately before it enters the furnace shaft 4 has a material entry temperature T3 which is lower than the critical temperature and higher than an ambient temperature RT. As can be seen from the illustrations in FIG. 1 to FIG. 4, the ambient temperature RT is measured in the illustrated embodiments in the immediate vicinity of the area where the perlite sand 1 enters the furnace shaft 4.

Preferably, the material temperature T3 is at least 30%, especially preferred at least 90%, of the critical temperature. In particular, the material entry temperature T3 can be at least 240° C., preferably at least 720° C.

The amount of heat transferred from the perlite sand 1 to the quantity of air and thus the time of expansion can be regulated very sensitively—even within a heating zone 7—by the amount of the heating. An increase in the material entry temperature T3 causes an earlier onset of expansion and usually also leads to lighter expanded granulate 2. A reduction in the material entry temperature T3 leads to opposite effects. A further advantage is that the reduced heat emission of perlite sand 1 to the quantity of air in furnace shaft 4 results in a more homogeneous temperature distribution in the perlite sand 1 to be expanded and thus a more evenly expanded granulate 2.

In the embodiment example of FIG. 1, compressed air 15 heated to the material entry temperature T3 is provided as at least one means provided upstream of the furnace shaft 4 for heating the perlite sand 1, which forms the air quantity heated to a second elevated temperature T2. To provide the air quantity heated to the second elevated temperature T2, a heating 22 of the compressed air tank 21 is provided. The heating 22 can be controlled by means of a controllable valve 32, which can be controlled by the regulating and control unit 16. The second elevated temperature T2 of the heated air quantity is monitored by a temperature sensor 23, which is also connected to the regulating and control unit 16 (indicated by the dashed line), so that the regulating and control unit 16 can regulate the heating 22 by means of the controllable valve 32 in such a way that the desired second elevated temperature T2 is reached. In the illustrated embodiment, the temperature sensor 23 measures the second elevated temperature T2 of the quantity of air directly in front of the solid/air nozzle 14, i.e. between the solid/air nozzle 14 and the compressed air tank 21. The quantity of air heated in this way heats the perlite sand 1 during dispersion to the material entry temperature T3, which will typically be lower than the second elevated temperature T2 in the embodiment example of FIG. 1.

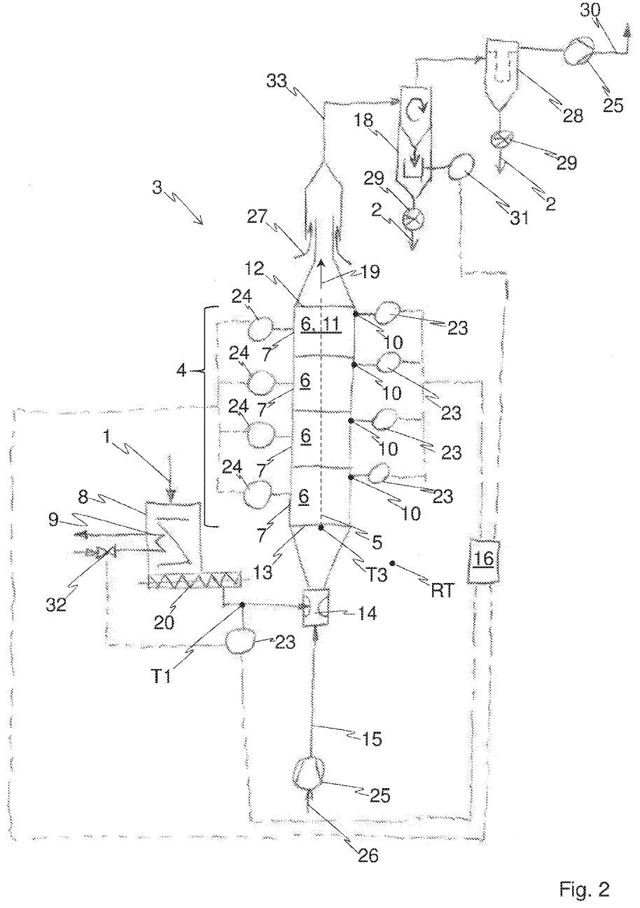

In the second embodiment example according to FIG. 2 no compressed air tank 21—and thus also no heating 22 of the compressed air tank 21—is provided, but the compressed air 15 forming the quantity of air is fed directly to the solid/air nozzle 14 by means of the fan/compressor 25. To heat the perlite sand 1 to the material entry temperature T3, a heating 9 is provided in the storage container 8 instead to heat the perlite sand 1 in the storage container 8. The heating is carried out in such a way that the perlite sand 1 has a first elevated temperature T1 before entering the solid/air nozzle 14 or before dispersing.

This first elevated temperature T1 is less than the critical temperature and greater than the ambient temperature RT and can be measured using a temperature sensor 23 upstream of the solid/air nozzle 14. This temperature sensor 23, which measures the first elevated temperature T1 of perlite sand 1 between the dosing screw 20 and the solid/air nozzle 14 in the embodiment example shown, is connected to the regulating and control unit 16 (indicated by the dashed line). The heating 9 of the storage container 8 also has a controllable valve 32 which is connected to and controlled by the regulating and control unit 16 (indicated by the dashed line). The first elevated temperature T1 of the heated perlite sand 1 is monitored by the temperature sensor 23 of the regulating and control unit 16 so that the regulating and control unit 16 can regulate the heating 9 by means of the controllable valve 32 in such a way that the desired first elevated temperature T1 is reached. When dispersing with the (unheated) quantity of air, the perlite sand 1 typically cools down somewhat by heat transfer to the quantity of air, so that its material entry temperature T3 is typically somewhat lower than the first elevated temperature T1 in the embodiment example in FIG. 2.

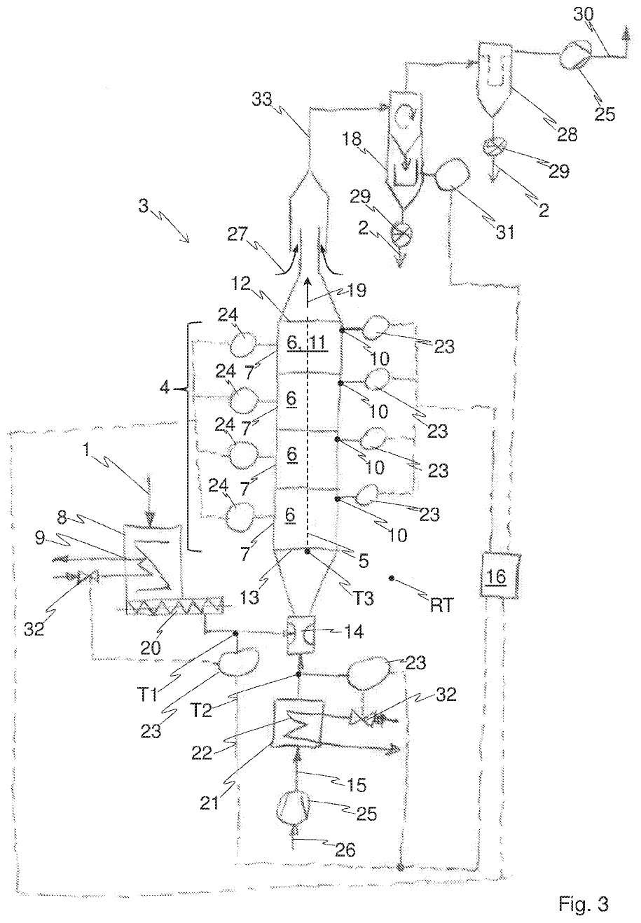

The third embodiment example according to FIG. 3 is a combination of the embodiment examples from FIG. 1 and FIG. 2. On the one hand, the quantity of air is heated by means of the heating 22 of the compressed air tank 21, so that the quantity of air immediately before entering the solid/air nozzle 14 has the second elevated temperature T2. On the other hand, the perlite sand 1 in the storage container 8 is also heated by means of the heating 9, so that the perlite sand 1 immediately before entering the solid/air nozzle 14 has the first elevated temperature T1. The result is a particularly precise setting of the desired material entry temperature T3.

Preferably, the absolute value of a differential temperature, which is the difference between the first elevated temperature T1 and the second elevated temperature T2, is at most 50%, preferably at most 30%, particularly preferably at most 10%, of the first elevated temperature T1.

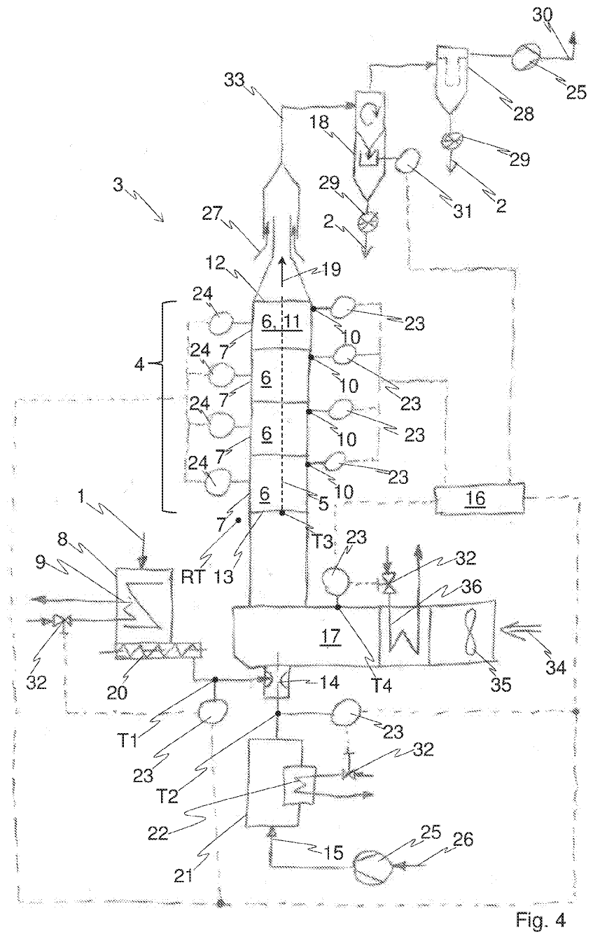

In the fourth embodiment example according to FIG. 4, compared to the third embodiment example according to FIG. 3, the supply of supply air 34 is additionally provided, which is blown into the furnace shaft 4 from below, in order to support the conveying of the perlite sand 1 or the expanded granulate 2 along the conveying path 5, wherein the supply air 34 is preheated to a further elevated temperature T4 before it enters the furnace shaft 4. Preferably, the further elevated temperature T4 is also higher than the ambient temperature RT and lower than the critical temperature. Preheating the supply air 34 prevents a large part of the heating of perlite sand 1 caused by the heating process from being transferred to the supply air 34 by convection. By heating or preheating the perlite sand 1 and the supply air 34 before each entry into furnace shaft 4, a shorter furnace shaft 4 can be built or regulated much more sensitively.

In the embodiment example in FIG. 4, a fan 35 and a pipe 17 are provided as means for supplying or injecting the supply air 34. The supply air 34 is blown into pipe 17 by means of fan 35, wherein a heating 36 is arranged in pipe 17 in order to preheat the supply air 34 to the further elevated temperature T4. The fan 35 and the heating 36 are therefore connected upstream of the furnace shaft 4. The heating 36 comprises a controllable valve 32 connected to and controlled by the regulating and control unit 16 (indicated by the dashed lines). The further elevated temperature T4 of the preheated supply air 34 is measured by means of a temperature sensor 23, preferably at a point in the pipe 17 downstream of the heating 36. This temperature sensor 23 is also connected to the regulating and control unit 16 (indicated by the dashed line), which evaluates its signals to control the heating 36 by means of the controllable valve 32 in such a way that the further elevated temperature T4 of the preheated supply air 34 has a desired value.

In the embodiment example shown, the pipe 17 leads into an area which is directly connected to the solid/air nozzle 14. This means that the pipe 17 is connected at least in sections on the one hand between the solid/air nozzle 14 and the furnace shaft 4 and on the other hand between the heating 36 and the furnace shaft 4 in order to be able to convey the preheated supply air 34 into a region between the solid/air nozzle 14 and the lower end 13 of the furnace shaft 4. In this way, the preheated supply air 34 is added to the dispersed perlite sand 1. Preferably, the further elevated temperature T4 of the preheated supply air 34 is selected so that it is at least as high as that of the dispersed perlite sand 1 in order to prevent the perlite sand 1 from cooling due to the addition of the preheated supply air 34. Accordingly, the desired material entry temperature T3 can be set with high precision.

In all the embodiment examples shown, the gas-material flow 33 is fed to a density measuring device 18, where at least part of the expanded granulate 2 carried in the gas-material flow 33 is separated. The density measuring device 18 has a sensor 31 which determines the density of this expanded granulate 2 in a manner known per se, e.g. optically. This expanded granulate 2 is discharged from the density measuring device 18 via a rotary valve 29 and can, for example, be fed to a silo (not shown).

In addition, a filter 28 downstream of the density measuring device 18 is provided in order to separate as completely as possible the expanded granulate 2 still present in the gas-material flow 33. Since the expanded granulate 2 or the gas-material flow 33 is cooled down by the cooling air 27, in particular to a temperature less than or equal to 120° C., it is possible to use inexpensive, in particular cleanable, filter hoses in filter 28. This expanded granulate 2 is also discharged from filter 28 via a rotary valve 29 and can, for example, be fed to a silo (not shown).

Exhaust air 30 cleaned by the filter 28 is released into the atmosphere via a fan 25 downstream of the filter 28.

The determination of the density of the expanded granulate 2 makes it possible to regulate the expansion or swelling process even more sensitively. The measurement allows the expansion result to be monitored continuously and process parameters to be adjusted immediately if the actual expansion result deviates from the desired expansion result. By connecting the regulating and control unit 16 also to the sensor 31 (indicated by the dashed line) and continuously evaluating its data, the density of the expanded microspheres 2 can be specifically regulated by means of the regulating and control unit 16 in order to guarantee the desired quality of the expansion result.

In particular, the power of at least one heating element 7 of a last heating zone 11 can be controlled to regulate the density of the expanded granulate 2, wherein its power is preferably controlled to a desired value or a value in a desired value range. This allows at least a coarse control of the density of the expanded granulate 2.

By means of the detection of the temperature drop described above, the heating elements 7 of the heating zones 6 before the last heating zone 11 are preferably regulated in such a way that the isenthalpic expansion process takes place before, in particular immediately before, the last heating zone 11. This means that the detection of the position of the temperature drop is used to at least roughly regulate this position to a desired position along the conveying path 5, namely to a position before, in particular immediately before, the last heating zone 11, by suitable control of the heating elements 7 by means of the regulating and control unit 16.

An extremely fine adjustment of the position of the temperature drop is made possible by the control of the material entry temperature T3, wherein the first elevated temperature T1 and/or the second elevated temperature T2 and/or the further elevated temperature T4 are suitably controlled by means of the regulating and control unit 16. Accordingly, for extremely fine regulation of the density of the expanded granulate 2, the first elevated temperature T1 and/or the second elevated temperature T2 and/or the further elevated temperature T4 can be suitably controlled by means of the regulating and control unit 16.

It should be noted that the homogeneity of the expanded granulate 2 can also be determined completely analogously to the determination of the density of the expanded granulate 2 and that this homogeneity can then be used as an alternative or additional regulating variable in order to guarantee the desired quality of the expansion result or the expanded granulate 2.

### LIST OF REFERENCE NUMERALS

1 Perlite sand
2 Expanded granulate/expanded microspheres
3 Furnace
4 Furnace shaft
5 Conveying path
6 Heating zone
7 Heating element
8 Storage container
9 Heating of the storage container
10 Position for temperature measurement along the conveying path
11 Last heating zone
12 Upper end of furnace shaft
13 Lower end of furnace shaft
14 Solid/air nozzle
15 Compressed air
16 Regulating and control unit
17 Pipe for supply air
18 Density measuring device
19 Conveying direction
20 Dosing screw
21 Compressed air tank
22 Heating of the compressed air tank
23 Temperature sensor
24 Current or power meter
25 Fan/compressor
26 Air supply
27 Cooling air
28 Filter
29 Rotary valve
30 Purified exhaust air
31 Sensor of the density measuring device
32 Controllable valve
33 Gas-material flow
34 Supply air
35 Fan
36 Heating for supply air
T1 First elevated temperature (of the material)
T2 Second elevated temperature (of the air quantity)
T3 Material entry temperature
T4 Further elevated temperature (of supply air)
RT Ambient temperature

1: A method for producing an expanded granulate (2) from sand grain-shaped mineral material (1) having an expanding agent, for example for producing an expanded granulate from perlite sand (1) or obsidian sand; wherein the material (1) is fed into a furnace (3); wherein the material (1) is conveyed in a substantially vertically disposed furnace shaft (4) of the furnace (3) along a conveying path (5) through a plurality of heating zones (6) arranged vertically separated from one another, wherein each heating zone (6) can be heated with at least one independently controllable heating element (7); wherein the material (1) is thereby heated to a critical temperature at which the surfaces of the sand grains (1) become plastic and the sand grains (1) are expanded due to the expanding agent; wherein the expanded material (2) is discharged from the furnace (3), wherein furthermore the material (1) is fed together with a quantity of air from below, wherein the material (1) is conveyed from bottom to top along the conveying path (5) by means of the quantity of air flowing from bottom to top in the furnace shaft (4) and forming an air flow, and wherein the expansion of the sand grains (1) takes place in the upper half of the conveying path (5), wherein the material (1) is heated so that the material (1), immediately before its entry into the furnace shaft (4), has a material entry temperature (T3) which is lower than the critical temperature and higher than an ambient temperature (RT).

2: The method according to claim 1, wherein the quantity of air is heated to a second elevated temperature (T2) which is lower than the critical temperature and higher than the ambient temperature (RT).

3. (canceled)

4. (canceled)

5. (canceled)

6: The method according to claim 2, wherein at least the quantity of air heated to the second elevated temperature (T2) is provided as means for heating the material (1) to the material entry temperature (T3).

7. (canceled)

8. (canceled)

9. (canceled)

10. (canceled)

11. (canceled)

12. (canceled)

13: The method according to claim 1, wherein, upon detection of a first reduction in the temperature of the material (1) between two successive positions (10) along the conveying path (5), the heating elements (7) along the remaining conveying path (5) are regulated as a function of the critical temperature in order to prevent or selectively enable an increase in the material temperature along the remaining conveying path (5) to or above the critical temperature.

14: The method according to claim 1, wherein, after discharge, the size and/or density of the expanded sand grains (2) is determined, preferably continuously.

15: The method according to claim 14, wherein, in order to regulate the density of the expanded sand grains (2), the power of the at least one heating element (7) of a last heating zone (11) is controlled.

16: The method according to claim 13, wherein, in order to regulate a position of the detected first reduction in the temperature of the material (1) apart from the power of the at least one heating element (7) of a last heating zone (11), the powers of the heating elements (7) of all heating zones (6) are controlled.

17. (canceled)

18. (canceled)

19. (canceled)

20: The method according to claim 1, wherein the material entry temperature (T3) is at least 30% of the critical temperature.

21: The method according to claim 1, wherein the material entry temperature (T3) is at least 240° C.

22: The method according to claim 1, wherein additionally supply air (34) is injected and/or aspirated into the furnace shaft (4) from below in order to support the conveying of the material (1) along the conveying path (5), wherein the supply air (34) is preheated to a further elevated temperature (T4) before it enters the furnace shaft (4).

23. (canceled)

24: A device for producing an expanded granulate (2) from sand grain-shaped mineral material (1) having an expanding agent, for example for producing an expanded granulate from perlite (1) or obsidian sand, the device comprising a furnace (3) with a substantially vertically disposed furnace shaft (4), which has an upper end (12) and a lower end (13), wherein a conveying path (5) extends between the two ends (12, 13) through a plurality of heating zones (6) arranged vertically separated from one another, wherein the heating zones (6) each have at least one heating element (7) which can be controlled independently of one another in order to heat the material (1) to a critical temperature and to expand the sand grains (1), wherein furthermore at least one feed means (14) is also provided in order to expand the non-expanded material (1) together with a quantity of air at the lower end (13) of the furnace shaft (4) in the direction of the upper end (12) of the furnace shaft (4) into the furnace shaft (4) in such a way that the quantity of air forms an air flow flowing from bottom to top, by means of which the material (1) is conveyed from bottom to top along the conveying path (5) in order to be expanded in the upper half of the conveying path (5), wherein at least one means, upstream of the furnace shaft (4), for heating the material (1) is provided in order to ensure that the material (1), when it enters the furnace shaft (4), has a material entry temperature (T3) which is lower than the critical temperature and higher than an ambient temperature (RT).

25: The device according to claim 24, wherein at least one means is provided upstream of the furnace shaft (4) for heating the air quantity to a second elevated temperature (T2) which is lower than the critical temperature and higher than the ambient temperature (RT).

26. (canceled)

27. (canceled)

28. (canceled)

29: The device according to claim 25, wherein at least the quantity of air heated to the second elevated temperature (T2) is provided as means for heating the material (1) to the material entry temperature (T3).

30. (canceled)

31. (canceled)

32. (canceled)

33. (canceled)

34. (canceled)

35: The device according to claim 24, wherein material temperature measuring means (23, 24) are provided for directly and/or indirectly measuring the temperature and/or the temperature change of the material (1) along the conveying path (5) and a regulating and control unit (16) connected to the material temperature measuring means (23, 24) and to the heating elements (7) of the heating zones (6) in order to detect a first reduction of the temperature of the material (1) between two successive positions (10) along the conveying path (5), and wherein the heating elements (7) can be regulated by the regulating and control unit (16) as a function of the critical temperature in order to prevent an increase in the material temperature along the remaining conveying path (5) to or above the critical temperature or to make it possible in a targeted manner.

36: The device according to claim 24, wherein means (18, 19) are provided for the determination of the size and/or the density of the expanded sand grains (2).

37: The device according to claim 36, wherein a regulating and control unit (16) is provided which is designed in such a way that, in order to regulate the density of the expanded sand grains (2), the power of the at least one heating element (7) of a last heating zone (11) is controlled.

38. (canceled)

39: (canceled)

40. (canceled)

41. (canceled)

42: The device according to claim 24, wherein the material entry temperature (T3) is at least 30% of the critical temperature.

43: The device according to claim 24, wherein the material entry temperature (T3) is at least 240° C.

44: The device according to claim 24, wherein at least one means (35, 17) is provided in order to inject and/or aspirate supply air (34) from below into the furnace shaft (4) in order to support the conveying of the material (1) along the conveying path (5), and wherein at least one means (36) is provided for preheating the supply air (34) to a further elevated temperature (T4) which is connected upstream of the furnace shaft (4).

45. (canceled)
